(19) United States
(12) Patent Application Publication
(10) Pub. No.: US 2010/0284076 A1
(43) Pub. Date: Nov. 11, 2010

(54) Wavelength dispersion compensation device

(75) Inventors: Kohei Shibata, Kawasaki (JP); Nobuhiro Fukushima, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/976,076

(22) Filed: Oct. 19, 2007

Related U.S. Application Data
(63) Continuation-in-part of application No. 11/506,941, filed on Aug. 21, 2006, now abandoned.

(30) Foreign Application Priority Data
Apr. 7, 2006 (JP) 2006-106497
Mar. 30, 2007 (JP) 2007-092631

(51) Int. Cl. G02B 27/28; G02B 1/10; G02B 26/00

(52) U.S. Cl. 359/495; 359/584; 359/578

(57) ABSTRACT

A wavelength dispersion compensation device includes an etalon 100 having a slab shape. Reflective films are formed on each side of the etalon 100. The reflective films respectively have predetermined reflectance. Reflectance of one of the reflective films differs according to a light incident angle by using a portion of light within a wavelength range to be used with which a filter characteristic in which transmittance rapidly changes is obtained.

### CROSS-REFERENCE TO RELATED APPLICATIONS

This application is a continuation-in-part application of application Ser. No. 11/506,941 filed Aug. 21, 2006, and is based upon the prior Japanese Patent Application No. 2007-092631 filed on Mar. 30, 2007, the latter and the former being based upon the prior Japanese Patent Application No. 2006-106497, filed on Apr. 7, 2006.

### BACKGROUND OF THE INVENTION

1. Field of the Invention

The present invention relates a dispersion compensation device used in optical communication.

2. Description of the Related Art

When an optical signal pulse transmission is performed using an optical fiber, a speed of transmission through the optical fiber differs depending on a light wavelength. Therefore, as a transmission distance increases, a signal pulse waveform flattens. This phenomenon is referred to as wavelength dispersion. When the wavelength dispersion is generated, a reception level is significantly degraded. For example, when a single mode fiber (SMF) is used, a wavelength dispersion of −15 to −16 ps/nm·km is generated near a wavelength of 1.55 micrometers (μm) that is often used in optical pulse communication. In wavelength dispersion compensation (referred to as dispersion compensation), wavelength dispersion of the same amount as the wavelength dispersion generated when the optical fiber is used is conversely added.

Currently, a dispersion compensating fiber (DCF) is the most common optical fiber used to perform dispersion compensation. The DCF is designed to generate dispersion (structure dispersion) that is an opposite of material dispersion of a fiber material. The opposing dispersion is generated by a specific refractive index distribution. In total, the DCF generates dispersion that is an opposite of dispersion generated in an ordinary SMF (dispersion compensation of about 5 to 10 times the amount generated in an SMF of a same length). The DCF is connected to the SMF at a relay station, and a total dispersion is zero (cancelled).

In recent years, in response to increasing communication demands, further increase in capacity is required for large, capacity transmission using wavelength division multiplexing (WDM). In addition to reduction in intervals between wavelength multiplexing, increase in communication speed is required (for example, 40 Gb/s). As a result, wavelength dispersion tolerance decreases when relay distances are the same. Temperature fluctuations generated when the wavelength dispersion is generated using SMF also requires compensation. The temperature fluctuations are conventionally not a problem. An actualization of a wavelength dispersion compensator that can change the compensation amount is required, in addition to the conventional fixed type DCF.

Specifically, a wavelength division type optical dispersion compensator using an etalon (for example, Japanese Patent Laid-open Publication Nos. 2002-267834 and 2003-195192). A tunable optical dispersion compensator using a reflective etalon is disclosed as a reflection type wavelength dispersion compensator (for example, Japanese Patent Laid-open Publication No. 2004-191521).

FIG. 18A is a schematic of a conventional tunable optical dispersion compensator. A tunable optical dispersion compensator 1000 includes an etalon 1010 and a mirror 1020. The etalon 1010 is a Gires-Tournois (GT) etalon. A reflective film 1011 is formed on one side of the etalon 1010. The reflective film 1011 has reflectance that continuously differs along a certain direction. A reflective film 1012 is formed on another side of the etalon 1010. The reflective film 1012 has approximately 100% reflectance. The mirror 1020 has a high-reflectance reflective film 1021. The mirror 1020 is placed at a slight angle to the etalon 1010. A beam emitted from a collimator 1030 is reflected by the mirror 1020, resonated by the etalon 1010, and enters a collimator 1040.

FIG. 18B is a perspective view of the conventional tunable optical dispersion compensator. As shown in FIG. 7B, the etalon 1010 is attached to a slide rail 1061 on a linear slide 1060. The etalon 1010 slides along a direction X. A reflectance of the reflective film 1011 continuously changes along the direction X. A dispersion compensation amount can be changed by the sliding of the etalon 1010.

There is a wavelength dispersion compensator in which etalons that differ from each other in a group delay and a center wavelength are connected optically in series (for example, Japanese Patent Laid-Open Publication No. 2003-264505). FIG. 19 is a plot of a combined group delay characteristic when etalons are connected optically in series. In FIG. 19, characteristics 1901 to 1904 respectively indicate group delay characteristics of a plurality of etalons that differ in a group delay and a center wavelength from each other. A characteristic 1905 indicates a group delay characteristic obtained by combining the characteristics 1901 to 1904 when the respective etalons are connected optically in series.

FIG. 20A is a schematic of a conventional tunable dispersion compensator. A tunable dispersion compensator 2000 includes an input unit 2001, an optical circulator 2002, an etalon 2003a, an etalon 2003b, an output unit 2004, a Peltier device 2005, a power source 2006, and a temperature control unit 2007.

The optical circulator 2002 outputs light input from the input unit 2001 to the etalon 2003a, outputs light output from the etalon 2003a to the etalon 2003b, and outputs light output from the etalon 2003b to the output unit 2004.

The etalons 2003a and 2003b are the etalon 1010 explained in FIG. 18A, and differ from each other in a group delay and a center wavelength. The etalons 2003a and 2003b reflect light output from the optical circulator 2002 to the optical circulator 2002 by the reflective film 1011. In the etalon 2003a, the Peltier device 2005 is provided. The Peltier device 2005 changes the temperature of an etalon substrate of the etalon 2003a by the control of the power source 2006 and the temperature control unit 2007.

FIG. 20B is a plot of a group delay characteristic of the etalon 2003a. FIG. 20C is a plot of a group delay characteristic of the etalon 2003b. As shown in FIG. 20B, the group delay characteristic of the etalon 2003a is indicated as a quadratic function having a downward convex shape for the wavelength band used. As shown in FIG. 20C, the group delay characteristic of the etalon 2003b is indicated as a quadratic function having an upward convex shape for the wavelength band used.

FIGS. 21A to 21C are plots of a group delay characteristic of an etalon. A characteristic 2101 indicates a group delay characteristic of the etalon 2003a shown in FIG. 20B. A characteristic 2102 indicates a group delay characteristic of the etalon 2003b shown in FIG. 20C. A characteristic 2103 indicates a group delay characteristic that is obtained by combining the group delay characteristic 2101 and the group delay characteristic 2102.

When the center wavelengths of the group delay characteristic 2101 and the group delay characteristic 2102 are shifted by half the wavelength cycle interval FSR, as shown in FIG. 21A, the combined group delay characteristic 2103 becomes close to a direct function, and the slope becomes small. Therefore, the dispersion compensation amount becomes close to 0. If the shift amount of the center wavelengths of the group delay characteristic 2101 and the group delay characteristic 2102 is changed from half the wavelength cycle interval FSR, as shown in FIGS. 21B and 21C, the slope of the group delay characteristic 2103 becomes large, and the dispersion compensation amount increases.

The center wavelength of a group delay characteristic varies corresponding to thickness of an etalon substrate. Therefore, by adjusting the thickness of the etalon substrate by changing the temperature of the etalon substrate of the etalon 2003a using the power source 2006 and the temperature control unit 2007, the center wavelength of the group delay characteristic can be changed. Thus, the dispersion compensation amount can be changed.

However, the reflective film 1011 included in the etalon 1010 has low manufacturability and low uniformity. FIG. 22 is a schematic for illustrating a method of forming the reflective film. The reflective film 1011 on the etalon substrate 1010 is formed, for example, by layer formation. A low refractive index material and a high refractive index material are alternately layered as vapor-deposition materials. When forming the reflective film 1011, a deposition mask 1050 is slid in the direction X so that an area of each of layers 1011a to 1011n differs along the direction X. While forming the reflective film 1011, it is necessary to replace the deposition mask 1050 with a deposition mask that matches a mask area each time the deposition material is changed, or to slide the etalon substrate 1010 in the direction X. Thus, the reflective film takes time and labor to be formed, thereby inhibiting improvement in productivity.

Furthermore, because the deposition mask 1050 is used, a vapor-deposition material tends to leak onto a back surface of the deposition mask 1050. Therefore, it is difficult to form the layer in a uniform thickness, and special measures are required to be taken to solve the leakage. As a result, the etalon, which is a main component of the tunable optical dispersion compensator, becomes costly. In addition, it becomes difficult to acquire desired characteristics regarding the dispersion compensation amount of the tunable optical dispersion compensator.

Moreover, in the tunable dispersion compensator 2000 shown in FIG. 20A, the group delay cannot be varied. Accordingly, a variable range of the dispersion compensation amount cannot be increased.

### SUMMARY OF THE INVENTION

It is an object of the present invention to at least solve the above problems in the conventional technologies.

A wavelength dispersion compensation device according to one aspect of the present invention includes an etalon in a slab shape having at least two surfaces opposite to each other. The etalon includes reflective films formed on the surfaces respectively. One of the reflective films has incident angle dependence in which reflectance differs depending on an incident angle of the light, and has a filter characteristic in which the reflectance abruptly changes in a range of wavelength of light to be used for the wavelength dispersion compensation.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1A is a schematic of an etalon used in a wavelength dispersion compensation device according to an embodiment of the present invention;

FIG. 1B is a plot of a group delay characteristic of the etalon shown in FIG. 1A;

FIG. 1C is a plot of a group delay characteristic of the etalon shown in FIG. 1A;

FIG. 2 is a plot of a reflection characteristic of reflective films on the etalon;

FIG. 3 is a schematic for explaining a method of forming the reflective films;

FIG. 4A is a plot of a group delay characteristic when the etalon having the reflective films shown in FIG. 2 is configured in multistage;

FIG. 4B is a plot of a transmission characteristic when the etalon having the reflective films shown in FIG. 2 is configured in multistage;

FIG. 5 is a schematic of a wavelength dispersion compensating module;

FIG. 6 is a schematic of the etalon configured in multistage;

FIG. 7A is a schematic of a wavelength dispersion compensating module according to a second embodiment of the present invention;

FIG. 7B is a plot of a reflection characteristic of the etalon 100a;

FIG. 7C is a plot of a reflection characteristic of the etalon 100b;

FIG. 8 is a schematic illustrating variation of the incident angle of light to the reflective film of an etalon;

FIG. 9A is a graph showing relation between a group delay characteristic and a reflection characteristic;

FIG. 9B is a graph showing relation between a group delay characteristic and a reflection characteristic;

FIG. 10 is a table showing a design example of the etalon;

FIG. 11A is a plot of a group delay characteristic of the etalon in the setting 1;

FIG. 11B is a plot of a group delay characteristic of the etalon in the setting 2;

FIG. 11C is a plot of a group delay characteristic of the etalon in the setting 3;

FIG. 12A is a schematic illustrating reflection (one stage) of light at the etalon;

FIG. 12B is a schematic illustrating reflection (three stages) of light at the etalon;

FIG. 13A is a schematic of a wavelength dispersion compensating module according to a third embodiment;

FIG. 13B is a schematic of a modification of the wavelength dispersion compensating module shown in FIG. 13A;

FIG. 14 is a schematic illustrating adjustment of the distance between the two etalons;

FIG. 15A is a schematic of a modification of the wavelength dispersion compensating module;

FIG. 15B is a schematic of a modification of the wavelength dispersion compensating module;

FIG. 15C is a schematic of a modification of the wavelength dispersion compensating module;

FIG. 16 is a plot of a reflection characteristic of each polarization characteristic;

FIG. 17A is a schematic of a wavelength dispersion compensating module according to a fourth embodiment of the present invention;

FIG. 17B is a schematic of a modification of the wavelength dispersion compensating module;

FIG. 17C is a schematic of a modification of the wavelength dispersion compensating module;

FIG. 18A is a schematic of a conventional tunable optical dispersion compensator;

FIG. 18B is a perspective view of the conventional tunable optical dispersion compensator;

FIG. 19 is a plot of a combined group delay characteristic when etalons are connected optically in series;

FIG. 20A is a schematic of a conventional tunable dispersion compensator;

FIG. 20B is a plot of a group delay characteristic of the etalon 2003a;

FIG. 20C is a plot of a group delay characteristic of the etalon 2003b;

FIG. 21A is a plot of a group delay characteristic of an etalon;

FIG. 21B is a plot of a group delay characteristic of an etalon;

FIG. 21C is a plot of a group delay characteristic of an etalon; and

FIG. 22 is a schematic illustrating a method of forming the reflective film.

### DETAILED DESCRIPTION OF THE PREFERRED EMBODIMENTS

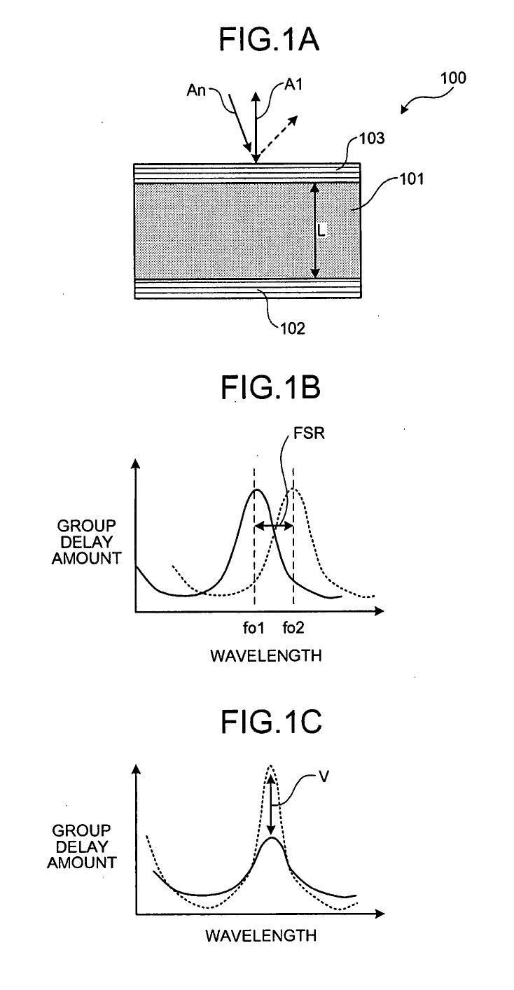

Exemplary embodiments of the present invention will be explained in detail below with reference to the accompanying drawings. FIG. 1A is a schematic of an etalon used in a wavelength dispersion compensation device according to the first embodiment of the present invention. A reflective etalon 100 includes a slab-shaped etalon substrate 101 and two reflective films 102 and 103. The etalon substrate 101 has thickness L. The two reflective films 102 and 103 are formed on opposite sides of the etalon substrate 101. One reflective film 102 has a mirror surface or a high-reflection coating. A reflectance of the reflective film 102 is set to almost 100%. Another reflective film 103 is a light incident side. A reflectance of the reflective film 103 is lower than that of the other reflective film 102.

FIG. 1B is a plot of a group delay characteristic of the etalon 100. A horizontal axis indicates wavelength. A vertical axis indicates a group delay amount. A central wavelength interval (free spectral range (FSR)) and a center wavelength (fo1, fo2, . . . . ) of the etalon 100 are set based on an optical distance between the two reflective films 102 and 103 (cavity length of the etalon substrate 101, thickness L shown in FIG. 1A).

FIG. 1C is a plot of a group delay characteristic of the etalon 100. A group delay amount (finesse V) is set based on the reflectance of the reflective film 103. The group delay amount determines a dispersion compensation amount. The reflective film 103 has a low reflectance.

A light incident angle of light incident on the etalon 100 continuously changes. Light A1 has a perpendicular incident angle to the reflective film 103. Light An has a predetermined angle. By varying the light incident angle, the group delay amount is varied, thereby changing the dispersion compensation amount.

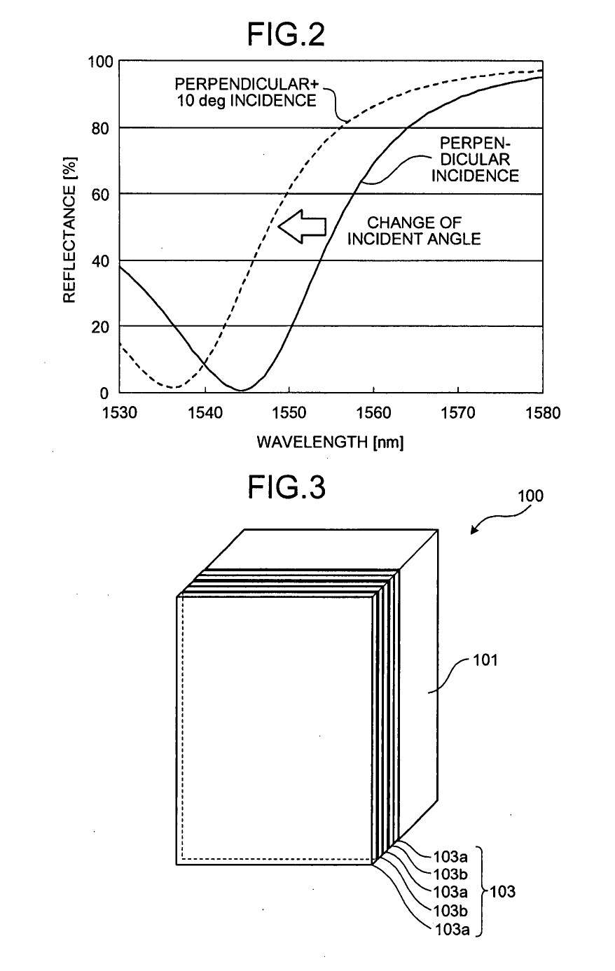

FIG. 2 is a plot of a reflection characteristic of the reflective film 103. The horizontal axis indicates the wavelength. The vertical axis indicates the reflectance. The reflective film 103 is set and formed so as to have a following characteristic. The reflectance of the reflective film 103 changes rapidly within a wavelength range to be used. As shown in FIG. 2, when the light incident angle to the reflective film 103 is perpendicular near a wavelength of 1550 nanometers (nm), the reflectance is 20%. When the light incident angle to the reflective film 103 is 10 degrees (perpendicular+10 deg incidence), the reflectance is 65%.

Therefore, when the light incident angle is changed by 10 degrees, the reflectance can be changed within a range of 20% to 65%. A characteristic of the reflective film 103, such as the above, can be actualized by setting the wavelength range to be used, to a portion (edge portion) at which filter characteristics of an optical band pass filter (BPF) and an optical band rejection filter (BRF) rapidly change. In addition, a state of changes in the reflectance with respect to the wavelength (a change rate and an angle of a characteristic line (slope)) can be arbitrarily set by adjusting the total number of layers in the reflective film 103 and thickness of each layer.

In the reflectance characteristic shown in FIG. 2, the reflectance has a continuous, rather than a gradual, wavelength dependence. The characteristic indicates that a generated group delay differs (changes) depending on wavelength. Therefore, the dispersion compensation amount can be continuously changed in a wavelength direction (every time the wavelength differs).

FIG. 3 is a schematic for explaining a method of forming the reflective film 103. The reflective film 103 is formed, for example, by alternately layering a film 103a of a low refractive index material and a film 103b of a high refractive index material by vapor-deposition. The films 103a and 103b are both formed on one side of the etalon substrate 101. The films 103a and 103b may be formed on the entire surface. Thus, a reflective film 103 having reflectance dependent on an incident angle can be formed. Each layer of the reflective film 103 can be easily formed, for example, to an arbitrary thickness by merely controlling a vapor-deposition time. A vapor-deposition mask is not required. Therefore, manufacturability can be improved, uniformity of the films can be enhanced, and characteristics for desired dispersion compensation amount can be easily acquired.

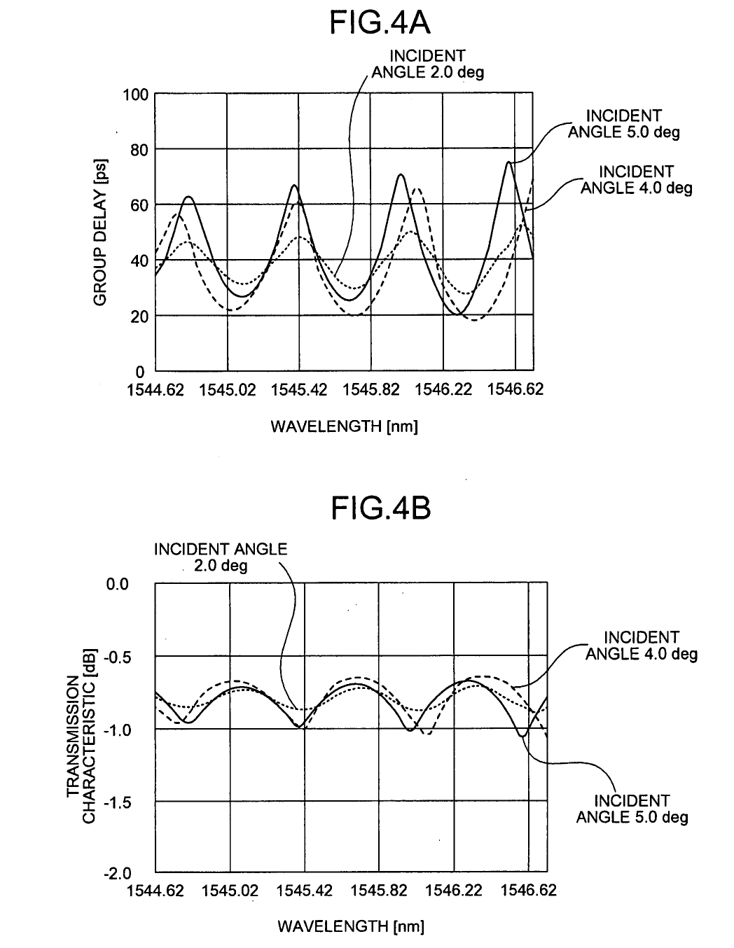

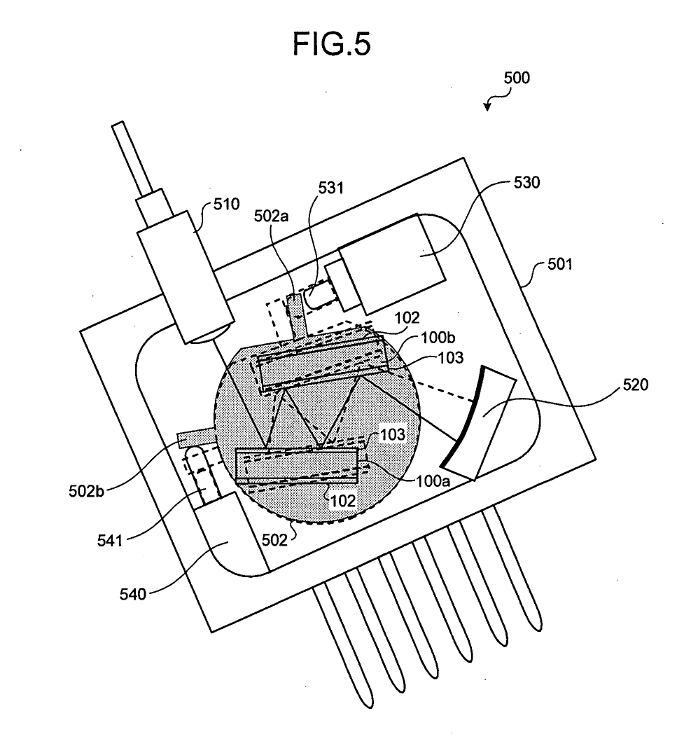

FIG. 4A is a plot of a group delay characteristic when the etalon having the reflective films shown in FIG. 2 is configured in multistage. FIG. 4B is a plot of a transmission characteristic when the etalon having the reflective films shown in FIG. 2 is configured in multistage. Respective characteristics when a light passes through the etalon in three stages. The etalon 100 is designed so that the characteristic line differs in each stage. The light can pass through the etalon 100 in each stage. Therefore, an effective bandwidth (wavelength range) on which dispersion compensation is performed by each channel, stipulated in an international telecommunication union (ITU) grid, can be increased.

FIG. 5 is a schematic of a wavelength dispersion compensating module 500. The wavelength dispersion compensating module 500 includes two units of the etalons 100 described above. Light is incident on and emitted from one optical port. A collimator 510 is placed in one area of a housing 501. The collimator 510 is on an end of an optical fiber. The two etalons 100 (100a and 100b) are placed within the housing 501. Light emitted from the collimator 510 is incident on the etalons 100a and 100b. The etalons 100a and 100b are placed so that the respective reflective films 103 face each other. A placement angle of the etalons 100a and 100b is substantially parallel. Alternatively, one of the etalons 100 can be placed at an angle to the other one of the etalons 100 as shown in FIG. 5.

As shown in the diagram, the light emitted from the collimator 510 passes through the etalon 100a and the etalon 100b, and then, the light is reflected by a reflective body 520 to be returned. A returning path is sequentially returned through the etalon 100b and then the etalon 100a, and the light is incident on the collimator 510. The wavelength dispersion compensation module 500 has four stages structure in total in both ways.

The two etalons 100a and 100b are arranged on a stage 502. The stage 502 is rotatable about a rotation center of the stage 502 that is an approximately intermediate position between the two etalons 100a and 100b. The stage 502 is rotated by a rotation mechanism, and functions as an incident angle changing unit to change the incident angle of the light incident on the etalon 100a. The light is emitted from the collimator 510 that is an optical port. The rotation mechanism includes an extruding mechanism 530 and a biasing mechanism 540. The extruding mechanism 530 and the biasing mechanism 540 are provided beside the stage 502. The extruding mechanism 530 includes a combination of a stepping motor and a gear, or a piezo element and the like. In the extruding mechanism 530, a differential piece 531 extrudes a protrusion piece 502a of the stage 502 and rotates the stage 502. The biasing mechanism 540 includes a return spring and generates a bias force in a direction opposite of an extrusion direction of the extruding mechanism 530. The bias force is transmitted to a protrusion piece 502b of the stage 502, via a differential piece 541.

According to the wavelength dispersion compensating module 500, the stage 502 is rotated by the extruding mechanism 530 being operated. Due to the rotation, the incident angle of the light emitted from the collimator 510 to the two etalons 100a and 100b can be changed. For example, as shown in FIG. 4A and FIG. 4B, changes in the group delay frequency characteristic and the transmission characteristic corresponding to the light incident angle can be achieved (however, because the configuration shown in FIG. 5 is the four-stage structure, the characteristics thereof differ from that of the three-stage structure shown in FIG. 4A and FIG. 4B).

According to the configuration shown in FIG. 5, the light can be incident on and emitted from a single optical port. Therefore, the number of components in the wavelength dispersion compensating module 500 can be reduced and the wavelength dispersion compensating module 500 can be downsized. Furthermore, the wavelength dispersion compensating module 500 can be manufactured at a low cost. The configuration of the wavelength dispersion compensating module 500 is not limited to that described above. A light incident port and a light emitting port can be separately provided. In addition, as another configuration example of the rotation mechanism, a motor with a gear can be placed on the rotation center of the stage 502 to rotate the stage 502. Other than the configuration in which the stage 502 on which the etalon 100 is mounted is rotated, the light incident angle to the etalon 100 can be changed by the etalon 100 side being held stationary and the angle of the light incident port being changed. The light incident angle to the etalon 100 can be relatively changed. Although the wavelength dispersion compensating module 500 has the four-stage structure, the configuration is not limited thereto. The wavelength dispersion compensating module 500 can have multiple stages and an arbitrary dispersion compensation amount can be attained.

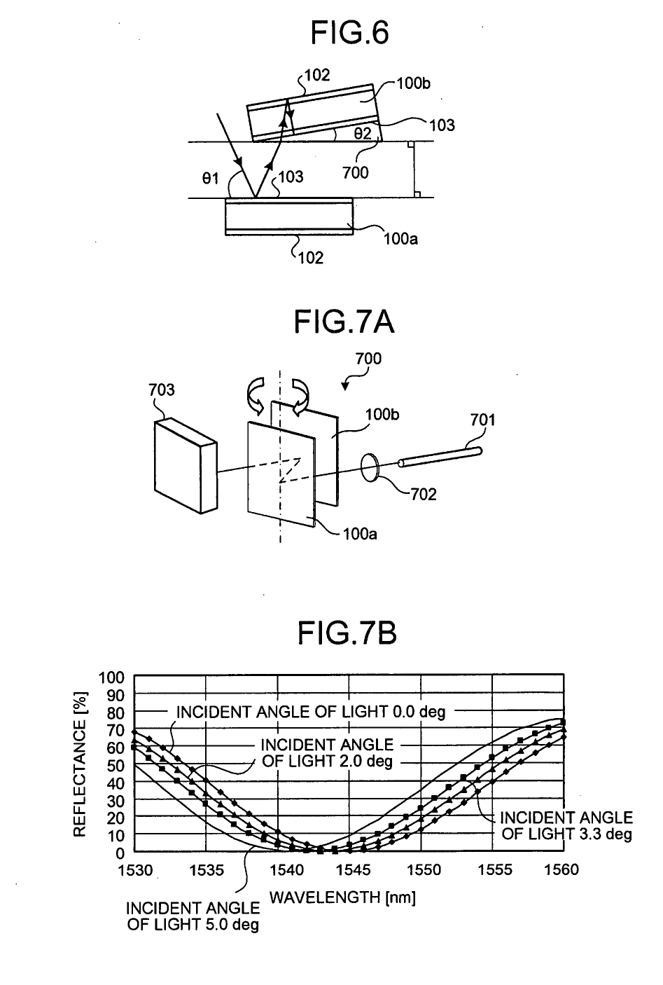

FIG. 6 is a schematic of an etalon configured in multistage. The placement of the two etalons 100a and 100b is the same as that in FIG. 5. A light refracting component 700, for example, a prism, is placed on a surface of the reflective film 103 of the etalon 100b. The light refracting component 700 has a tilt angle θ2 so that the incident surface is parallel to the surface of the reflective film 103 of the etalon 100a. In the example shown in FIG. 6, the tilt angle θ2 of the light refracting component 700 is almost equal to a light incident angle θ1 to the etalon 100a. As a result, the incident angle of the light incident on the etalon 100b can be adjusted depending on the tilt angle θ2.

According to the configuration shown in FIG. 6, the same etalon can be applied to the etalons 100a and 100b opposing to each other to form the multi-stage configuration. In addition, it is possible to configure the etalon such that the etalon 100a and the etalon 100b have different compensation amounts, as a slope characteristic (see FIG. 4A and FIG. 4B) when the etalon is configured in multistage. The compensation amount between each stage can be varied by a use of the etalons 100a and 100b, and dispersion compensation of all stages combined can be performed. Furthermore, changes in wavelength interval difference (FSR) can be suppressed, even when there is a plurality of stages.

According to the first embodiment explained above, the reflective film having a different reflectance depending on the light incident angle can be easily formed. Therefore, the manufacturability of the etalon can be improved, and the wavelength dispersion compensation device can be manufactured at a low cost. Furthermore, the reflectance can be made wavelength dependent. As a result, a wavelength dispersion compensation module that corresponds to required dispersion compensation characteristics can be manufactured.

The etalon substrate 101 can be formed with silicon or zinc selenide that are high-refraction materials. By a use of the high-refraction material, the changes in the wavelength interval caused by the changes in the light incident angle can be suppressed. Therefore, a variable range (number of wavelengths) can be increased.

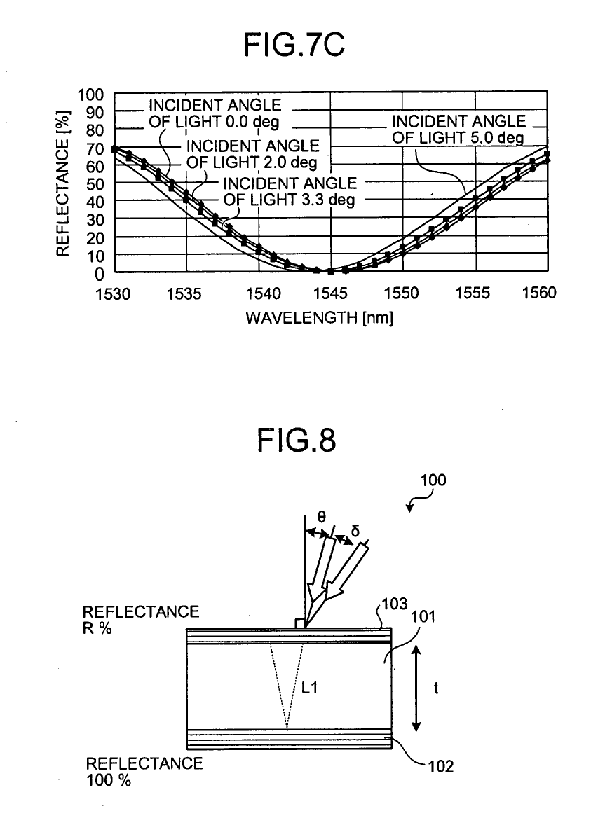

FIG. 7A is a schematic of a wavelength dispersion compensating module according to the second embodiment of the present invention. This wavelength dispersion compensating module 700 is a configuration example in which two pieces of the etalons 100 that differ from each other in a reflection characteristic are used, and in which input and output of light are performed by a single optical port. Light input from an input/output fiber 701 is collimated into a parallel beam by a collimator 702 and is output to the two etalons 100a and 100b.

The light output to the two etalons 100a and 100b is reflected at the etalons 100a and 100b to a planar mirror 703. The planar mirror 703 reflects the light from the two etalons 100a and 100b back to the etalons 100a and 100b. The light returned by the planar mirror 703 is reflected again at the two etalons 100a and 100b, passes through the collimator 702, and is output from the input/output fiber 701.

The two etalons 100a and 100b rotate about the same axis (see, for example, the rotation mechanism in FIG. 5). Thus, the incident angle of the light output from the input/output fiber 701 to the reflective film 103 of the etalon 100a is varied.

FIG. 7B is a plot of a reflection characteristic of the etalon 100a. FIG. 7C is a plot of a reflection characteristic of the etalon 100b. As described above, the reflectance of the etalons 100a and 100b varies depending on the incident angle of light. As shown in FIGS. 7B and 7C, the etalons 100a and 100b have different reflection characteristics from each other.

FIG. 8 is a schematic illustrating variation of the incident angle of light to the reflective film of an etalon. As shown in FIG. 8, the incident angle of light to the reflective film 103 is indicated by θ, the change of the incident angle is indicated by δ, an optical path length of light that passes through the reflective film 103, is reflected by the reflective film 102, and is input again to the reflective film 103 is indicated by L1, and the thickness of the etalon substrate 101 is indicated by t.

Moreover, the reflectance (%) of the reflective film 103 is indicated by R. A phase shift amount h (λ) can be expressed by Equation 1 below when the optical path length of the etalon 100 is L1, a refractive index of the etalon substrate 101 is n, and the wavelength of light to be input is λ.

h(λ)=exp[−j2π·L1·n/λ] (1)

Furthermore, the optical path length L1 can be expressed by Equation 2 below using the thickness t of the etalon substrate 101 and the incident angle θ of light to the reflective film 103.

L1=2·t/{square root over ((1−(sin θ/n)²))} (2)

A transfer function H (λ) can be expressed by Equation 3 below using the reflectance R of the reflective film 103 and the attenuation ratio A of reflection at the reflective film 103.

$$H ( λ ) = \frac{A \cdot h ( λ ) - \sqrt{( R / 100 )}}{A \cdot h ( λ ) \cdot \sqrt{( R / 100 )} - 1} \qquad ( 3 )$$

A group delay D (λ) can be expressed by Equation 4 below in which a phase part argH (λ) in the transfer function and is differentiated by ω(=2πc/λ).

D(λ)=−(λ²/2πc)(d/dλ)(argH(λ)) (4)

Relation between the wavelength cycle interval FSR (Hz) of the group delay D (λ) and the optical path length L1 is determined by h (λ) having periodicity, and is a change of λ in which an element L1·n/λ of this h (λ) is integrally multiplied. The wavelength cycle interval FSR (Hz) can be expressed by Equation 5 below when a speed of light is C.

FSR(Hz)=C(L1·n),C(speed of light) (5)

Furthermore, the thickness t of the etalon substrate 101 when the wavelength cycle interval FSR (Hz) of the group delay D (λ) and the incident angle θ are specified can be expressed by Equation 6 below.

t=C/(2·n·FSR·\sqrt{1−(sin θ/n)²}) (6)

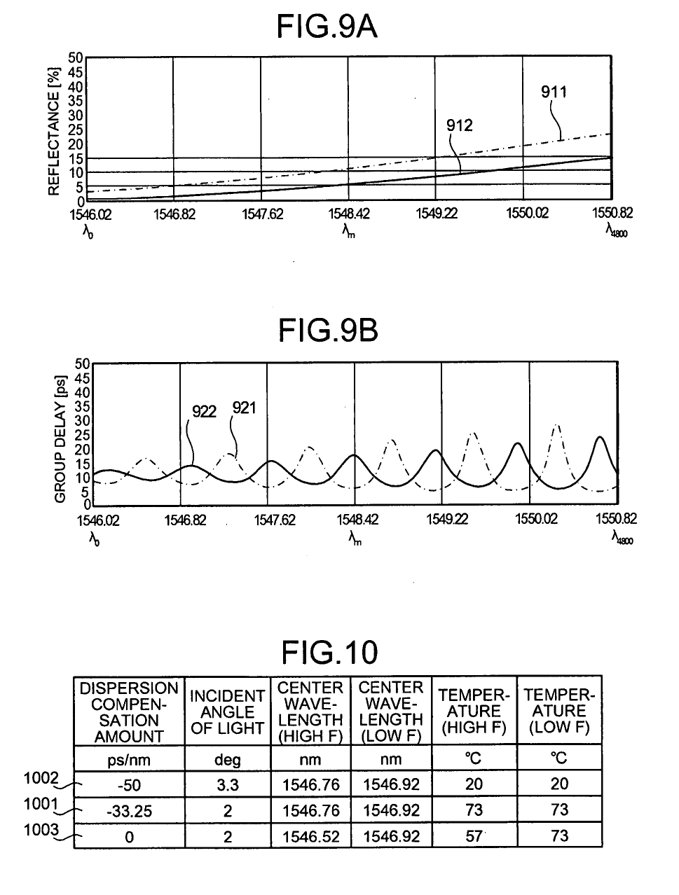

FIG. 9A is a graph showing relation between a group delay characteristic and a reflection characteristic. FIG. 9A illustrates the reflection characteristic of the reflective film 103 when the wavelength cycle interval FSR (Hz) of the group delay D (λ) is 100 GHz. A characteristic 911 indicates the reflection characteristic of the reflective film 103 of the etalon 100a. A characteristic 912 indicates the reflection characteristic of the reflective film 103 of the etalon 100b.

FIG. 9B is a graph showing relation between a group delay characteristic and a reflection characteristic. FIG. 9B shows the group delay characteristic of the etalon 100 when the wavelength cycle interval FSR (Hz) of the group delay D (λ) is 100 GHz. A characteristic 921 indicates the group delay characteristic of the etalon 100a. A characteristic 922 indicates the group delay characteristic of the etalon 100b. As shown in FIGS. 9A and 9B, the slope of the group delay D (λ) increases as the reflectance R of the reflective film 103 increases.

FIG. 10 is a table showing a design example of the etalon. In the first column in the table shown in FIG. 10, a dispersion compensation amount (ps/nm) when the number of stages of reflection of light at the two etalons 100a and 100b is set to 1 is indicated. In the second column, an incident angle (deg) of light to the reflective film 103 of the etalon 100a is indicated. In the third column, a center wavelength (nm) of a group delay characteristic of the etalon 100a (high F) is indicated. In the fourth column, a center wavelength (nm) of a group delay characteristic of the etalon 100b (low F) is indicated. In the fifth column, temperature (° C.) of the etalon substrate 101 of the etalon 100a is indicated. In the sixth column, temperature (° C.) of the etalon substrate 101 of the etalon 100b is indicated.

Numerals 1001 to 1003 indicate settings 1 to 3, respectively. For the setting 1, the incident angle θ of light to the reflective film 103 of the etalon 100a from the input/output fiber 701 is set as 2.0 deg, the temperature of the etalon substrate 101 of the etalon 100a is set as 73° C., and the temperature of the etalon substrate 101 of the etalon 100b is set as 73° C. The center wavelength of the group delay characteristic in the etalon 100a is 1546.76 nm, and the center wavelength of the group delay characteristic in the etalon 100b is 1546.92 nm. In the setting 1, a group delay characteristic of −33.25 ps/nm can be obtained.

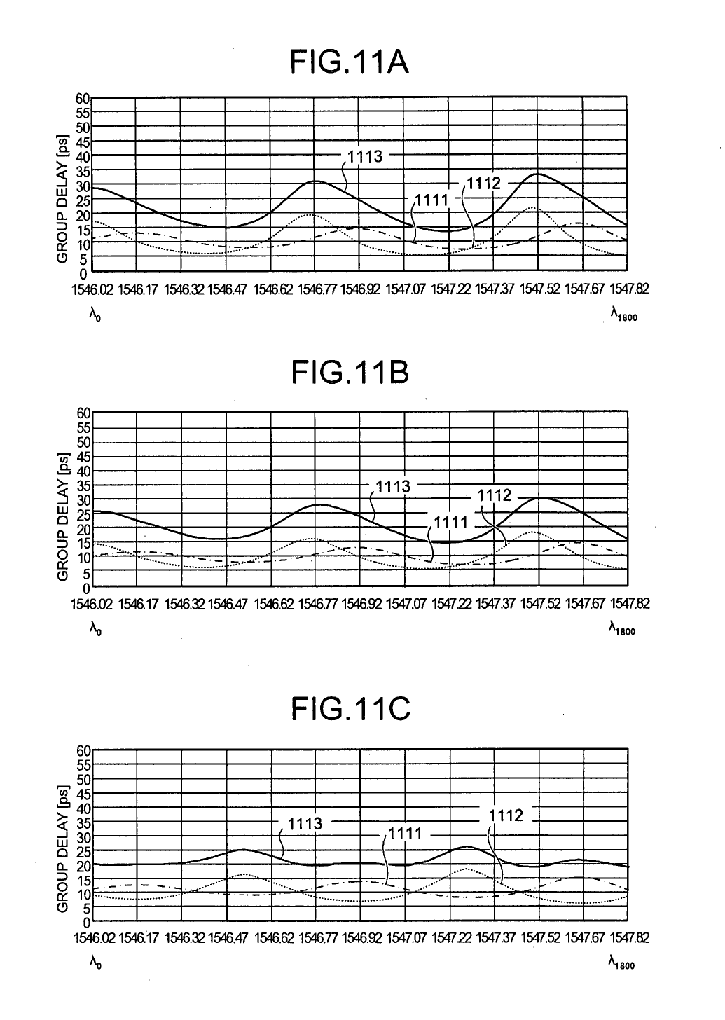

FIG. 11A is a plot of a group delay characteristic of the etalon in the setting 1. A characteristic 1111 indicates a group delay characteristic of the etalon 100a. A characteristic 1112 indicates a group delay characteristic of the etalon 100b. A characteristic 1113 indicates a group delay characteristic obtained by combining the group delay characteristics of the two etalons 100a and 100b.

Next, the setting 2 to obtain a group delay characteristic of a dispersion compensation amount larger than that in the setting 1 is explained. FIG. 11B is a plot of a group delay characteristic of the etalon in the setting 2. For the setting 2, the incident angle θ of light to the reflective film 103 of the etalon 100a from the input/output fiber 701 is set as 3.3 deg, the temperature of the etalon 100a is set as 20° C., and the temperature of the etalon 100b is set as 20° C. (see FIG. 10). The center wavelength of the group delay characteristic in the etalon 100a is 1546.76 nm, and the center wavelength of the group delay characteristic in the etalon 100b is 1546.92 nm. In the setting 2, a group delay characteristic of −50 ps/nm can be obtained.

As described, in a region of a large compensation amount, the dispersion compensation amount can be adjusted by changing the incident angle θ of light to the reflective film 103 of the etalon 100a from the input/output fiber 701. The center wavelength of the group delay characteristic of the etalon 100 is determined by the optical path length L1 of the etalon 100. Therefore, when the incident angle θ of light is changed, the optical path length L1 changes, and the center wavelength of the group delay characteristic changes. It is necessary to suppress a change of the center wavelength by adjusting the optical path length L1 of the etalon 100.

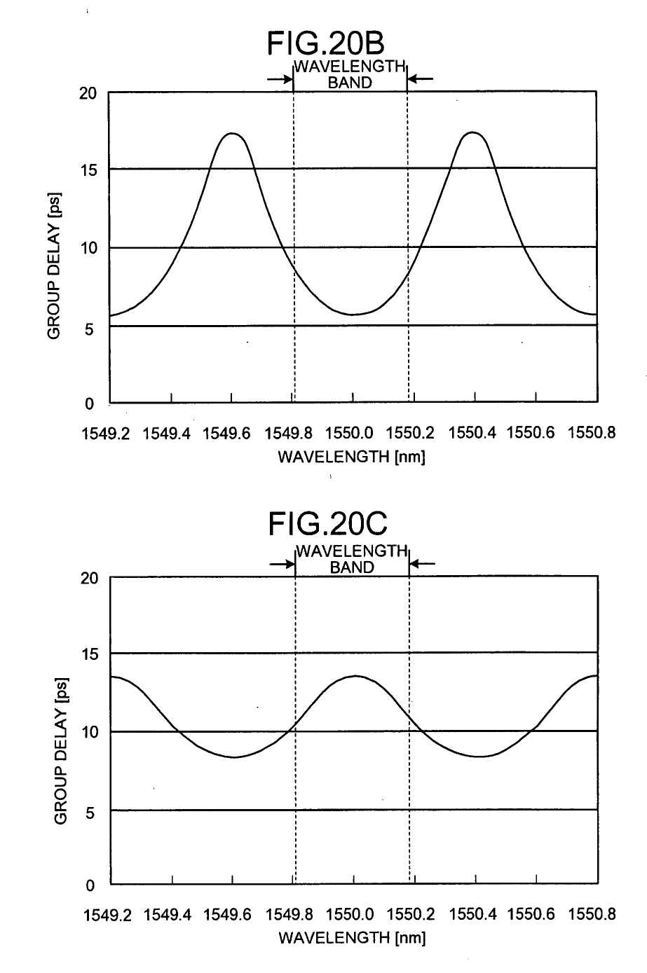

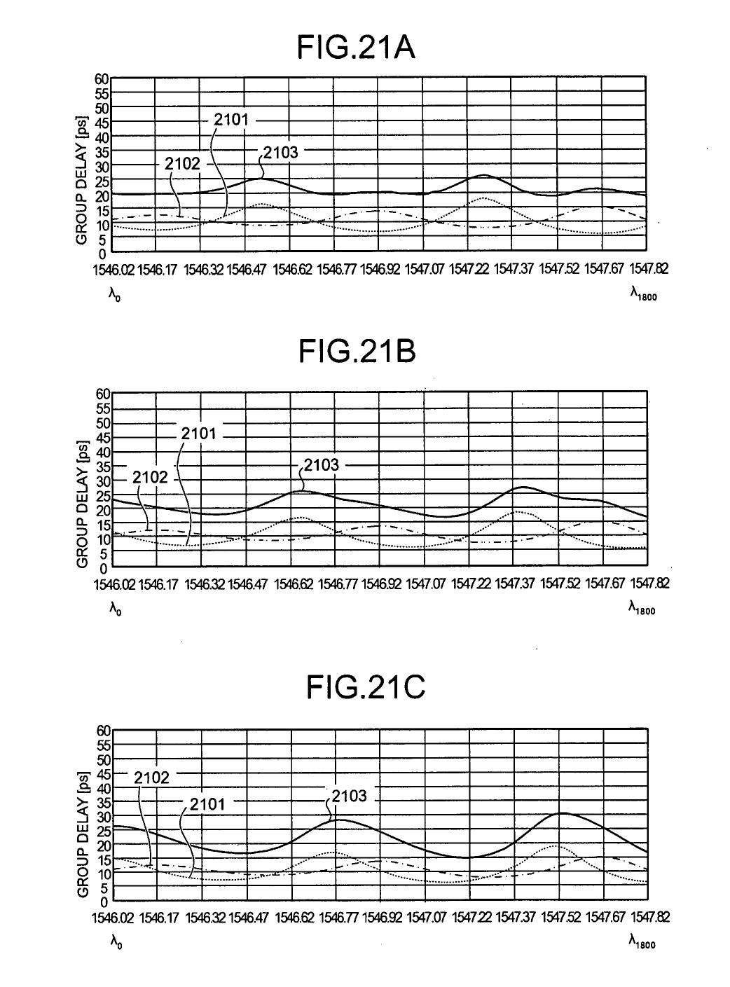

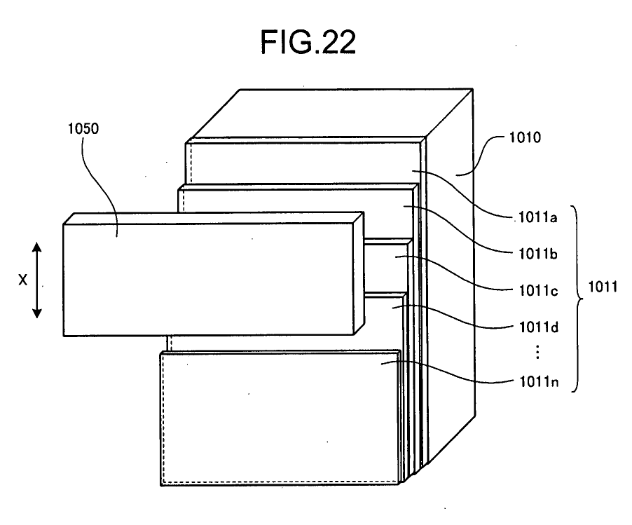

For example, the optical path length L1 is controlled by adjusting temperature of the etalon substrate 101. Specifically, configuration may be such that a Peltier device and a control unit of the Peltier device are provided in at least one of the etalons 100a and 100b, and the temperature of the etalon substrate 101 is changed by the Peltier device (see FIG. 20). To maintain the center wavelength constant with respect to a change δ of the incident angle θ, L1·n is controlled to be constant. The optical path length L1 with respect to the incident angle θ+δ can be expressed by Equation 7 below.

L1(θ+δ)=2·t/{square root over ((1−(sin(θ+δ/n)²))} (7)

The refractive index n of the etalon substrate 101 and the thickness t of the etalon substrate 101 in Equations 1 to 6 above are dependent on temperature, and the refractive index n (T) of the etalon substrate 101 can be expressed by Equation 8 below when an initial temperature of the etalon substrate 101 is T0, a control temperature of the etalon substrate 101 is T, a change of the refractive index n of the etalon substrate 101 according to the temperature control is (dn/dT)NdT, and a linear expansion coefficient is α. Furthermore, the thickness t of the etalon substrate 101 can be expressed by Equation 9 below.

n(T)=n₀·(1+NdT(T−T₀)) (8)

t(T)=t₀·(1+α(T−T₀)) (9)

Therefore, a condition to make L1·n constant can be expressed by Equation 10 below.

$$\begin{matrix}L 1 ( θ ) \cdot {n}_{0} = L 1 ( θ + δ ) \cdot n ( T ) \\ = \frac{2 \cdot {t}_{0} \cdot ( 1 + α ( T - {T}_{0} ) ) \cdot {n}_{0} \cdot ( 1 + NdT ( T - {T}_{0} ) )}{\sqrt{( 1 - {\{ sin ( θ + δ ) / ( {n}_{0} \cdot ( 1 + NdT ( T - {T}_{0} ) ) ) \}}^{2} )}}\end{matrix} \qquad ( 10 )$$

For example, when the etalon substrate 101 is made of quartz and the wavelength of light to be input is 1550 nm, NdT is 9×10⁻⁶, and the linear expansion coefficient α is 5·5×10⁻⁷. Therefore, to increase the incident angle θ, it is necessary to control (decrease) the temperature of the etalon substrate 101 from the initial temperature T0. As a realistic temperature variable range, it is, for example, set to approximately 50° C. at the maximum.

Next, the setting 3 to obtain a group delay characteristic of a dispersion compensation amount smaller than that in the setting 1 is explained. FIG. 11C is a plot of a group delay characteristic of the etalon in the setting 3. In the setting 3, the incident angle θ of light to the reflective film 103 of the etalon 100a from the input/output fiber 701 is set as 2.0 deg, the temperature of the etalon 100a is set as 57° C., and the temperature of the etalon 100b is set as 73° C. The center wavelength of the group delay characteristic in the etalon 100a is 1546.52 nm, and the center wavelength of the group delay characteristic in the etalon 100b is 1546.92 nm. In the setting 3, a group delay characteristic of 0 ps/nm (no dispersion compensation) can be obtained.

While in the region of a large compensation amount, the optical path length L1 (temperature) is controlled to be the same optical path length L1, in a region of a small compensation amount, for example, the optical path length L1 (center wavelength) of the etalon 100a is changed to shift the center wavelength by half the wavelength cycle interval (FSR), thereby obtaining the dispersion compensation amount of 0. By further shifting the center wavelength, inverse compensation is also possible.

In the region of a small compensation amount also, the dispersion compensation amount can be varied by changing the incident angle of light to the reflective film 103 of the etalon 100a. The reflective film 103 is designed such that the reflectance increases as the incident angle increases in the used wavelength band, and the temperature control range in the region of a large compensation amount and the temperature control range of the region of a small compensation amount are used in common, thereby enabling use in a realistic temperature range.

As described, with the wavelength dispersion compensation device according to the second embodiment, the effects of the wavelength dispersion compensation device according to the first embodiment can be achieved, and the dispersion compensation amount can also be set to 0 by connecting a plurality of etalons having different reflection characteristics optically in series.

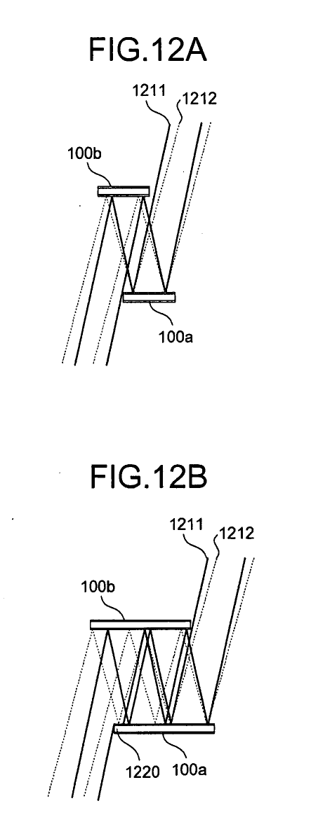

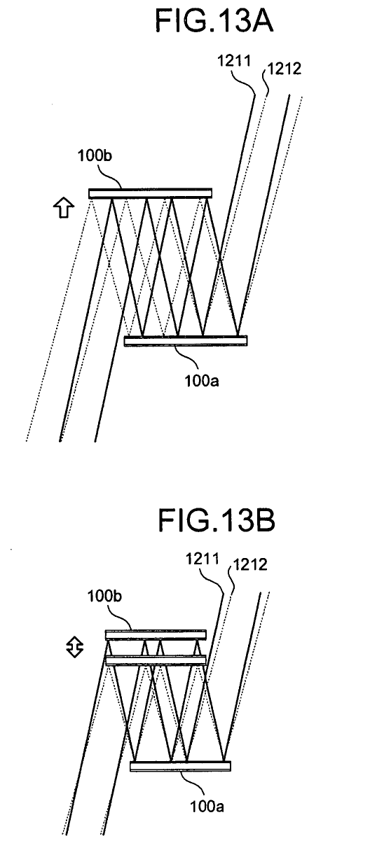

FIG. 12A is a schematic illustrating reflection (one stage) of light at the etalon. In FIG. 12A, two patterns of light beams 1211 (solid line) and 1212 (doted line) whose incident angles to the etalon 100a are different are shown. By thus changing the incident angle of light to the etalon 100a by rotating the two etalons 100a and 100b, the reflection characteristics of the two etalons 100a and 100b change (see FIGS. 7A and 7B). When the reflection characteristics of the two etalons 100a and 100b change, the group delay characteristics of the two etalon 100a and 100b change (see FIGS. 9A and 9B), thereby enabling to change the dispersion compensation amount.

FIG. 12B is a schematic illustrating reflection (three stages) of light at the etalon. With the configuration in which input light is reflected in a plurality of stages at the two etalons 100a and 100b as shown in FIG. 12B, the dispersion compensation amount can be made large. When the reflection of light at the two etalons 100a and 100b are multistaged, the two etalons 100a and 100b are arranged in parallel.

Depending on the incident angle of light from the input/output fiber 701 to the etalon 100a (for example, in the case of the light beam 1211), interference between an edge 1220 of the etalon 100a and the light can occur when light is emitted from the two etalons 100a and 100b. The interference becomes more likely to occur as the number of stages in which light is reflected at the etalons 100a and 100b are increased.

FIG. 13A is a schematic of a wavelength dispersion compensating module according to the third embodiment. As shown in FIG. 13A, configuration is such that a distance between the etalon 100a and the etalon 100b is increased so that the interference between the edge of the etalon 100a and the light is prevented. In this configuration, it is possible to make the dispersion compensation amount large by increasing the number of stages in which light is reflected at the etalons 100a and 100b, and to avoid the interference between the edge of the etalon 100a and the light.

FIG. 13B is a schematic of a modification of the wavelength dispersion compensating module shown in FIG. 13A. As shown in FIG. 13B, configuration may enable to adjustment of the distance between the two etalons 100a and 100b corresponding to a rotation angle of the two etalons 100a and 100b. In this example, configuration is such that the distance between the two etalons 100a and 100b is adjustable by making the position of the etalon 100b variable.

With this configuration, even if the number of stages in which light is reflected at the etalons 100a and 100b is increased, the distance between the two etalons 100a and 100b does not increase, and therefore, it is possible to avoid a size increase of the device. Moreover, since the rotation angle of the two etalons 100a and 100b and the distance between the two etalons 100a and 100b have a one-to-one correspondence, one-dimensional control is also possible.

A distance P between reflection points of light at the etalon 100a or the etalon 100b can be expressed by Equations 11 to 13 below when the distance between the etalons 100a and 100b is W.

P(θ+δ)=2·W·tan(θ+δ) (11)

P(θ)=2·W·tan(θ) (12)

ΔP=2·W·(tan(θ+δ)−tan(θ)) (13)

When the distance W between the two etalons 100a and 100b is constant, and the number of stages in which light is reflected at the two etalons 100a and 100b is m, an amount of change mΔP, where ΔP is an amount of change in the distance P, must be canceled if present. By controlling the distance W between the etalons 100a and 100b as in Equation 14 below, P can be made constant. Therefore, it is possible to prevent the interference between the edge of the etalon 100a and light when the light is output from the two etalons 100a and 100b.

W(δ)=P(θ)/2 tan(θ) (14)

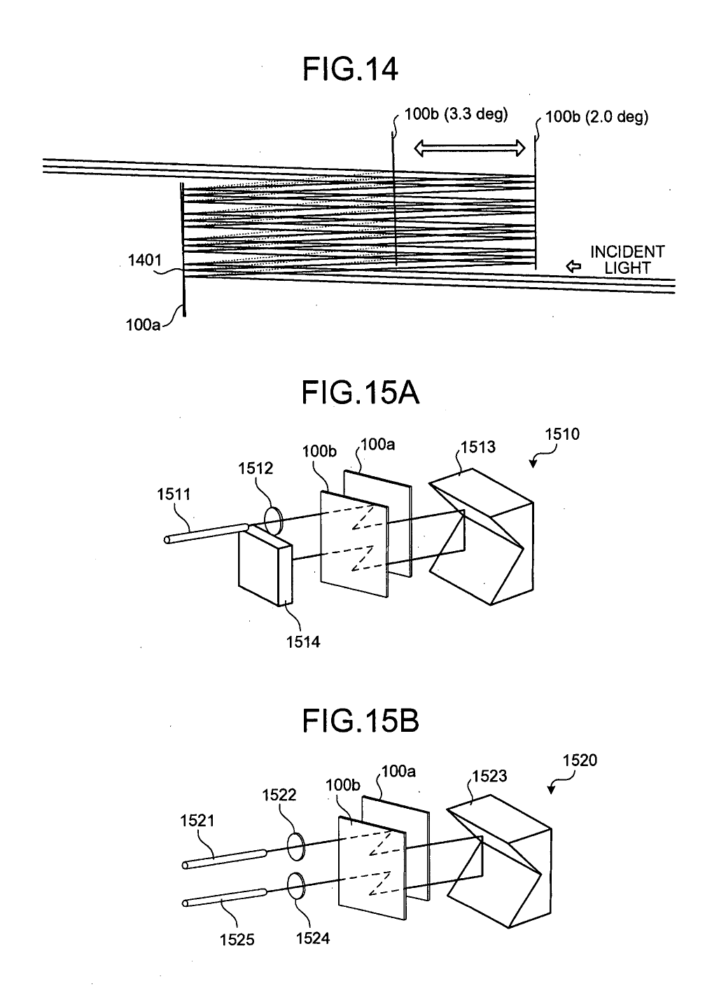

FIG. 14 is a schematic illustrating adjustment of the distance between the two etalons. FIG. 14 shows the positions of the etalon 100b when the rotation angle of the etalons 100a and 100b is 2.0 deg, and when the rotation angle is 3.3 deg. A solid line indicates an optical path when the rotation angle is set to 2.0 deg. A dotted line indicates an optical path when the rotation angle is set to 3.3 deg.

Configuration may be such that a point at which light enters the etalon 100a first is a rotation axis of the etalons 100a and 100b. With this arrangement, when configuration is such to return light output from the two etalons 100a and 100b by a mirror, an optical path of the returned light can be fixed to a position of an incident port even if the rotation angle of the etalons 100a and 100b changes. Therefore, it is not necessary to provide a mechanism to adjust the position of the port corresponding to the rotation angle of the two etalons 100a and 100b.

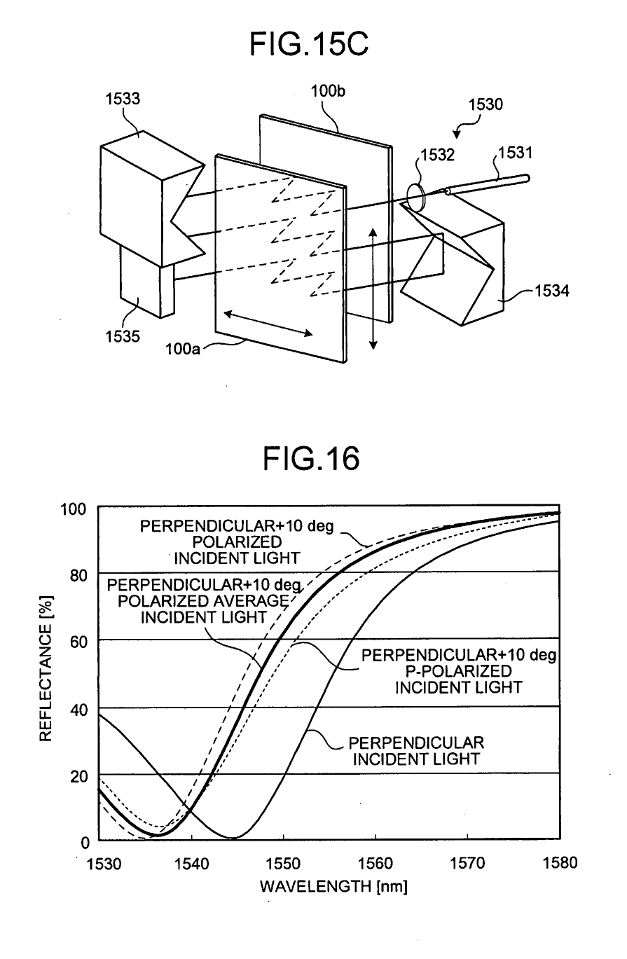

FIG. 15A is a schematic of a modification of the wavelength dispersion compensating module. This wavelength dispersion compensating module 1510 is a configuration example in which two pieces of the etalons 100 that differ from each other in a reflection characteristic are used, and in which the input and the output of light are performed by a single optical port. Light input from an input fiber 1511 is collimated into a parallel beam by a collimator 1512, and is reflected by the two etalons 100a and 100b. At a position at which the light beam reflected by the two etalons 100a and 100b is emitted, a recursive mirror 1513 is provided.

The recursive mirror 1513 reflects the light beam reflected from the two etalons 100a and 100b back toward the two etalons 100a and 100b as the height thereof changes (shifts). The recursive mirror 1513 is configured with two planar mirrors so that the optical path of the light beam before and after the reflection becomes parallel. The light beam returned by the recursive mirror 1513 is reflected again at the two etalons 100a and 100b.

At a position at which the light beam reflected again by the two etalons 100a and 100b is emitted, a returning planar mirror 1514 is provided. The returning planar mirror 1514 reflects the light beam reflected from the two etalons 100a and 100b back toward the two etalons 100a and 100b. The wavelength dispersion compensating module 1510 shown in FIG. 15A is configured to reflect light in four to-and-fro stages in total.

With the configuration shown in FIG. 15A, since light can be input and output from a single optical port, it is possible to reduce the number of parts of the wavelength dispersion compensating module 1510 to miniaturize the device, and to manufacture the device at a low cost. Furthermore, while in the wavelength dispersion compensating module 1510 described above has a four-staged configuration, it can be multistaged not being limited thereto, and an arbitrary dispersion compensation amount can be obtained.

As described, by multistaging in a vertical direction using the recursive mirror 1513, the dispersion compensation amount can be increased without increasing the number of stages in a horizontal direction. Therefore, it is possible to increase the dispersion compensation amount while suppressing the interference between the edge of the etalon 100a and light.

FIG. 15B is a schematic of a modification of the wavelength dispersion compensating module. This wavelength dispersion compensating module 1520 is a configuration example in which two pieces of the etalons 100 that differ from each other in a reflection characteristic are used, and in which the input and the output of light are performed by an incident port and an emitting port, respectively at different heights. Light input from an input fiber 1521 is collimated into a parallel beam by a collimator 1522, and is reflected by the two etalons 100a and 100b.

At a position at which the light beam reflected by the two etalons 100a and 100b is emitted, a recursive mirror 1523 is provided. The recursive mirror 1523 reflects the light beam reflected from the two etalons 100a and 100b back toward the two etalons 100a and 100b as the height thereof changes.

The light beam returned by the recursive mirror 1523 is reflected again at the two etalons 100a and 100b. The light reflected again by the two etalons 100a and 100b passes through a collimator 1524 to be output from an output fiber 1525. The wavelength dispersion compensating module 1520 is configured to reflect light in two to-and-fro stages, in total.

FIG. 15C is a schematic of a modification of the wavelength dispersion compensating module. This wavelength dispersion compensating module 1530 is a configuration example in which two pieces of the etalons 100 that differ from each other in a reflection characteristic are used, and in which the input and the output of light are performed by a single optical port. In this configuration, light incident to the two etalons 100a and 100b is reflected in two stages to be emitted. Light emitted from an input fiber 1531 passes through a collimator 1532, and is reflected by the two etalons 100a and 100b.

At a position at which the light beam reflected by the two etalons 100a and 100b is emitted, a recursive mirror 1533 is provided. The recursive mirror 1533 reflects the light beam reflected from the two etalons 100a and 100b back toward the two etalons 100a and 100b as the height thereof changes. The light beam returned by the recursive mirror 1533 is reflected again at the two etalons 100a and 100b.

At a position at which the light beam reflected again by the two etalons 100a and 100b is emitted, a recursive mirror 1543 is provided. The recursive mirror 1543 reflects the light beam reflected from the two etalons 100a and 100b back toward the two etalons 100a and 100b as the height thereof further changes. The light beam returned by the recursive mirror 1534 is reflected again at the two etalons 100a and 100b.

At a position at which the light beam reflected again by the two etalons 100a and 100b is emitted, a returning planar mirror 1535 is provided. The returning planar mirror 1535 reflects the light beam reflected from the two etalons 100a and 100b back toward the two etalons 100a and 100b. The wavelength dispersion compensating module 1530 shown in FIG. 15C is configured to reflect light in twelve to-and-fro stages, in total.

As described, with the wavelength dispersion compensation device according to the third embodiment, the effects of the wavelength dispersion compensation device according to the first embodiment and the second embodiment can be achieved, and occurrence of the interference between the edge of an etalon and light can be prevented while increasing the dispersion compensation amount by increasing the number of stages at which light is reflected by etalons.

FIG. 16 is a plot of a reflection characteristic of each polarization characteristic. When the reflective film 103 whose reflectance changes depending on an incident angle is used, it is necessary to pay attention to a polarization characteristic. As shown in FIG. 16, in the reflectance of the reflective film 103, a difference corresponding to polarization becomes significant as the incident angle increases. Therefore, a dispersion compensation characteristic becomes dependent on polarization.

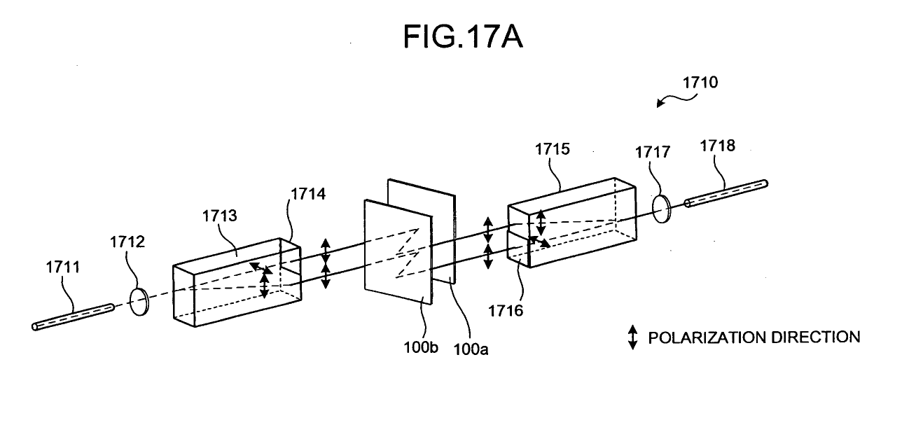

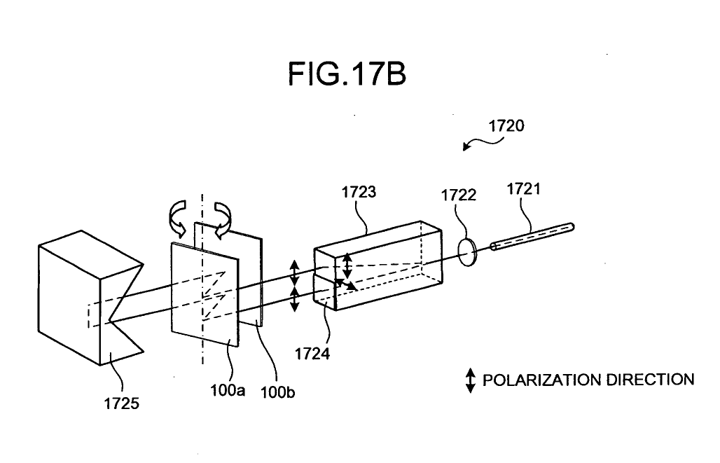

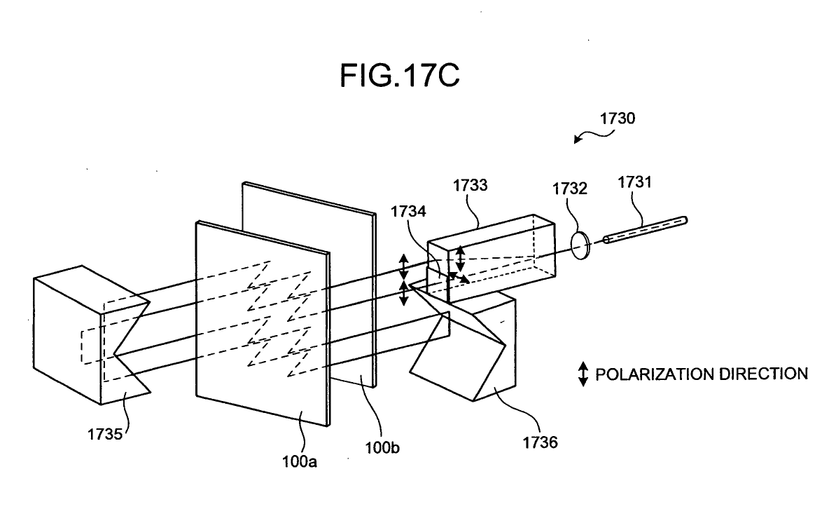

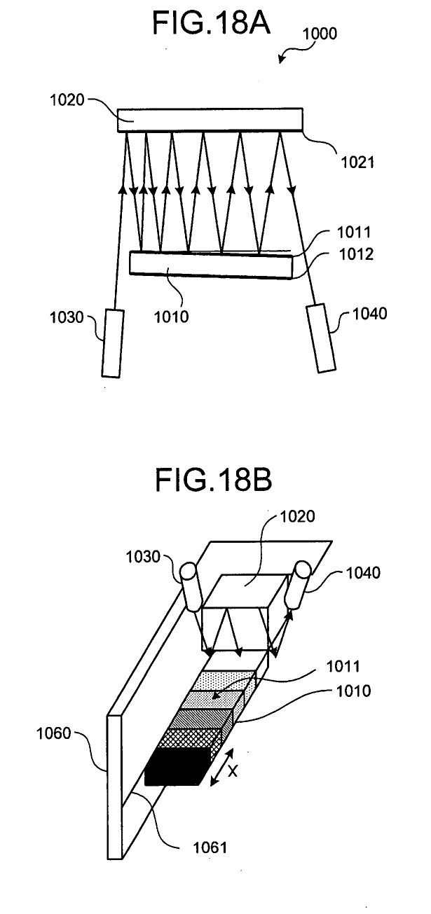

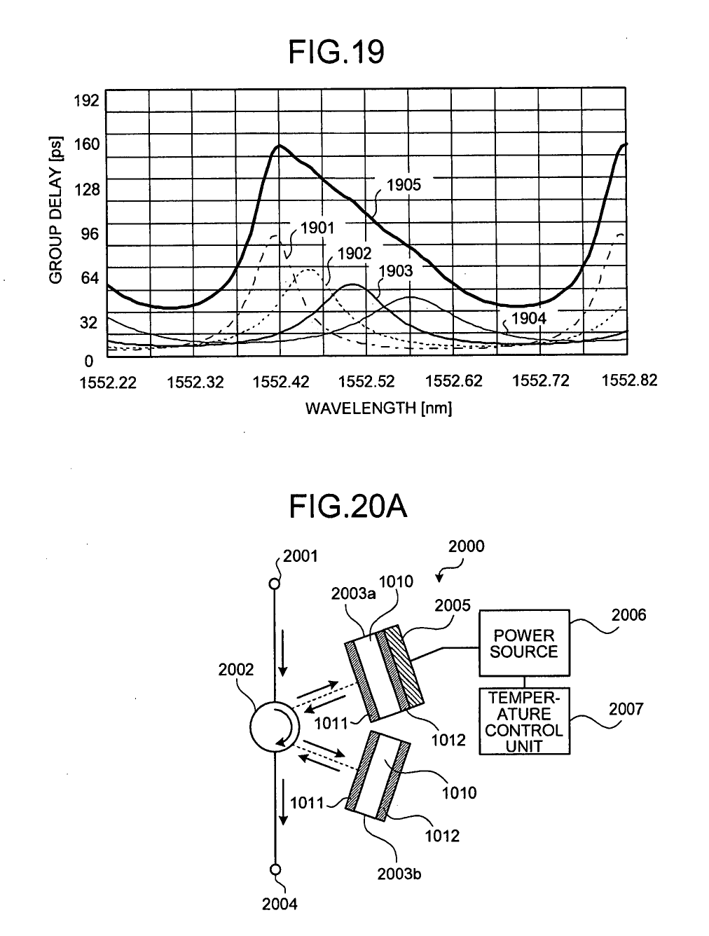

FIG. 17A is a schematic of a wavelength dispersion compensating module according to the fourth embodiment of the present invention. This wavelength dispersion compensating module 1710 is a configuration example in which two pieces of the etalons 100 that differ from each other in a reflection characteristic are used, and in which input and output of light are performed by an incident port and an emitting port. Light is output from an input fiber 1711, and at a position at which the light that has passed through a collimator 1712 is emitted, a birefringent crystal 1713 having a refractive index that differs depending on a polarization direction is provided.

The light incident to the birefringent crystal 1713 is divided, in polarization directions, into two light beams to be emitted. At a position from which one of the two light beams is emitted, a ½-wavelength plate 1714 is provided in the birefringent crystal 1713. The two light beams emitted from the birefringent crystal 1713 are reflected at the etalons 100a and 100b.

At a position at which the light beam reflected by the two etalons 100a and 100b is emitted, a birefringent crystal 1715 is provided. The light beams incident to the birefringent crystal 1715 are combined into a single light beam to be emitted from the birefringent crystal 1715. At a position at which the one of the two light beams that has not passed through the ½-wavelength plate 1714 is input to the birefringent crystal 1715, a ½-wavelength plate 1716 is provided. The light beam emitted from the birefringent crystal 1715 passes through a collimator 1717, and is output from an output fiber 1718.

FIG. 17B is a schematic of a modification of the wavelength dispersion compensating module. This wavelength dispersion compensating module 1720 is a configuration example in which two pieces of the etalons 100 that differ from each other in a reflection characteristic are used, and in which the input and the output of light are performed by a single optical port. Light emitted from an input/output fiber 1721 passes through a collimator 1722 to a birefringent crystal 1723.

The light incident to the birefringent crystal 1723 is divided into two light beams according to a polarization state to be emitted from the birefringent crystal 1723. At a position from which one of the two light beams is emitted in the birefringent crystal 1723, a ½-wavelength plate 1724 is provided.

The two light beams emitted from the birefringent crystal 1723 are reflected at the etalons 100a and 100b. At a position at which the light beams reflected by the two etalons 100a and 100b are emitted, a recursive mirror 1725 is provided. The recursive mirror 1725 reflects the light beams reflected from the two etalons 100a and 100b back toward the two etalons 100a and 100b while switching optical paths thereof.

The light beams returned by the recursive mirror 1725 are reflected again at the two etalons 100a and 100b. The light beams reflected again by the etalons 100a and 100b enter the birefringent crystal 1723 again. The light beams that have entered the birefringent crystal 1723 are combined into a single light beam to be emitted from the birefringent crystal 1723. The light emitted from the birefringent crystal 1723 passes through the collimator 1722 and is output from the input/output fiber 1721.

FIG. 17C is a schematic of a modification of the wavelength dispersion compensating module. This wavelength dispersion compensating module 1730 is a configuration example in which two pieces of the etalons 100 that differ from each other in a reflection characteristic are used, and in which the input and the output of light are performed by a single optical port. Light emitted from an input fiber 1731 passes through a collimator 1732 to a birefringent crystal 1733.

The light incident to the birefringent crystal 1733 is divided into two light beams according to a polarization state to be emitted from the birefringent crystal 1733. At a position from which one of the two light beams is emitted in the birefringent crystal 1733, a ½-wavelength plate 1734 is provided.

The two light beams emitted from the birefringent crystal 1733 are reflected at the etalons 100a and 100b. At a position at which the light beams reflected by the two etalons 100a and 100b are emitted, a recursive mirror 1735 is provided. The recursive mirror 1735 reflects the light beams reflected from the two etalons 100a and 100b back toward the two etalons 100a and 100b as the height thereof changes.

The light beams returned by the recursive mirror 1735 are reflected again at the two etalons 100a and 100b. At a position at which the light beams reflected again by the two etalons 100a and 100b are emitted, a recursive mirror 1736 is provided. The recursive mirror 1736 reflects the light beams reflected from the two etalons 100a and 100b back toward the two etalons 100a and 100b while switching optical paths thereof.

As described, with the wavelength dispersion compensating module according to the fourth embodiment, the effects of the wavelength dispersion compensation device according to the first to the third embodiments can be achieved, and by making a polarization state of light either one of a P-polarization and an S-polarization, a stable dispersion compensation amount can be set independent of a polarization state of input light. Moreover, by using a recursive mirror as a reflecting member to return light by reflection, variation of optical path length dependent on a polarization state is not caused.

According to each of the embodiments described above, a reflective film whose reflectance varies corresponding to an incident angle of light can be easily formed. Therefore, productivity of an etalon can be improved, and a wavelength dispersion compensating module can be manufactured at a low cost. Furthermore, since the reflectance can be made dependent on wavelength, a wavelength dispersion compensating module that corresponds to a required dispersion compensation characteristic can be manufactured.

The etalon substrate of the etalon 100 can be formed with a high refractive index material such as silicon and zinc selenide. By using a high refractive index material, variation of a wavelength interval caused by a change of the incident angle of light can be suppressed, and a variable range (wavelength) can be expanded.

Moreover, by connecting a plurality of etalons that differ from each other in a reflection characteristic optically in series, a dispersion compensation amount can also be set to 0. Furthermore, the occurrence of interference between an edge of an etalon and light can be prevented while increasing a dispersion compensation amount by increasing the number of stages in which light is reflected by the etalons. Moreover, a stable dispersion compensation amount can be set independent of a polarization state of input light.

According to the embodiments described above, it is possible to obtain required dispersion compensation amount with ease. Moreover, it is possible to manufacture a wavelength dispersion compensation device easily at low cost.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A wavelength dispersion compensation device comprising an etalon in a slab shape having at least two surfaces opposite to each other, and including reflective films formed on the surfaces respectively, wherein
one of the reflective films has incident angle dependence in which reflectance differs depending on an incident, angle of the light, and has a filter characteristic in which the reflectance abruptly changes in a range of wavelength of light to be used for the wavelength dispersion compensation.

2. The wavelength dispersion compensation device according to claim 1, wherein a rate of change of the reflectance in the range is set according to a desired wavelength dispersion characteristic.

3. The wavelength dispersion compensation device according to claim 1, wherein
one of the surfaces is a light incident surface, and
the one of the reflective films is a multilayer film formed on the light incident surface with a material having a high refraction index and a material having a low refraction index.

4. The wavelength dispersion compensation device according to claim 3, wherein number of layers formed with each of the material having a high refraction index and the material having a low refraction index is determined so that reflectance dependent on the incident angle is obtained.

5. The wavelength dispersion compensation device according to claim 3, wherein thickness of layers formed with each of the material having a high refraction index and the material having a low refraction index is determined so that reflectance dependent on the incident angle is obtained.

6. The wavelength dispersion compensation device according to claim 1, wherein
the etalon is arranged in plurality so as to oppose to each other, and
the wavelength dispersion compensation device further comprising:
an incident port from which the light is incident on one of the etalons;
an emitting port from which the incident light is emitted via the etalons; and
an angle changing unit configured to change an incident angle of the incident light.

7. The wavelength dispersion compensation device according to claim 6, further comprising a reflective body to replicate a path of the incident light, the path passing through the etalons, wherein
the incident port and the emitting port are one common optical port.

8. The wavelength dispersion compensation device according to claim 6, wherein the angle changing unit includes a rotating unit configured to rotate a stage on which the etalons are mounted.

9. The wavelength dispersion compensation device according to claim 6, wherein
the etalons are arranged such that the incident surface of each of the etalons face each other having a predetermined tilt angle to each other, and
one of the etalons includes a light refracting member to adjust the light incident angle to the light incident surface according to the desired wavelength dispersion characteristic.

10. The wavelength dispersion compensation device according to claim 1, wherein a substrate of the etalon is formed with a high-refraction material.

11. The wavelength dispersion compensation device according to claim 10, wherein the high-refraction material includes silicon.

12. The wavelength dispersion compensation device according to claim 10, wherein the high-refraction material includes zinc selenide.

13. The wavelength dispersion compensation device according to claim 3, wherein the multilayer film is formed on substantially entire surface of the light incident surface.

14. The wavelength dispersion compensation device according to claim 1, wherein the etalons, the reflective films of which have different reflection characteristics, are connected optically in series.

15. The wavelength dispersion compensation device according to claim 14, further comprising a temperature control mechanism that makes optical thickness of the etalon variable by controlling temperature of the etalon substrate.

16. The wavelength dispersion compensation device according to claim 14, wherein a difference between center wavelengths of the etalons can be set to be substantially half a wavelength cycle interval of the etalons.

17. The wavelength dispersion compensation device according to claim 14, wherein the reflection characteristic is set such that the reflectance increases as the incident angle of the light increases.

18. The wavelength dispersion compensation device according to claim 14, wherein the etalons are arranged in parallel to each other.

19. The wavelength dispersion compensation device according to claim 14, further comprising a distance adjusting mechanism that adjusts a distance between the etalons corresponding to the incident angle of the light.

20. The wavelength dispersion compensation device according to claim 14, further comprising a second reflective body that reflects light that has passed the etalons back to the etalons.

21. The wavelength dispersion compensation device according to claim 14, further comprising:
a second reflective body that reflects light that has passed the etalons back to the etalons while shifting an optical path thereof; and
a third reflective body that reflects the light that has been returned by the second reflective body and that has then passed through the etalons.

22. The wavelength dispersion compensation device according to claim 14, further comprising:
a first birefringent device that divides light to be input to the etalons into a plurality of light beams;
a first ½-wavelength plate that transmits one of the light beams;
a second birefringent device that combines the light beams that have passed through the etalons; and
a second ½-wavelength plate that passes a light beam that has not passed through the first ½-wavelength plate, among the light beams that have passed through the etalons and that have been emitted to the second birefringent device.

23. The wavelength dispersion compensation device according to claim 14, further comprising:
a birefringent device that divides light to be input to the etalons into a plurality of light beams;
a ½-wavelength plate that transmits one of the light beams; and
a second reflective body that reflects light beams that have passed the etalons back to the etalons while switching optical paths thereof.

24. The wavelength dispersion compensation device according to claim 20, further comprising:
a birefringent device that divides light to be input to the etalons into a plurality of light beams;
a ½-wavelength plate that transmits one of the light beams; and
a third reflective body that reflects light beams that have passed the etalons back to the etalons while switching optical paths thereof.
